(19) United States
(12) Patent Application Publication
(10) Pub. No.: US 2014/0121956 A1
(43) Pub. Date: May 1, 2014

(54) SYSTEM AND METHOD FOR RANGE CALCULATION IN VEHICLES

(71) Applicant: Fisker Automotive, Inc., Anaheim, CA (US)

(72) Inventor: Mark JASTRZEBSKI, South Lyon, MI (US)

(73) Assignee: Fisker Automotive, Inc., Anaheim, CA (US)

(21) Appl. No.: 13/895,570

(22) Filed: May 16, 2013

Related U.S. Application Data
(63) Continuation of application No. 13/638,393, now abandoned.
(60) Provisional application No. 61/319,553, filed on Mar. 31, 2010.

(51) Int. Cl. G01F 9/02

(52) U.S. Cl. CPC G01F 9/023
USPC 701/123

(57) ABSTRACT

A system for calculating the operating distance range remaining for a vehicle. The system includes a driver input sensor for sensing predetermined vehicle operating condition data, an energy storage sensor for sensing energy storage capacity data of a corresponding energy supply mechanism, a controller in communication with the driver input sensor and the energy storage sensor. An executable range calculation software program is stored in the memory of the controller which uses sensed vehicle operating condition data from the driver input sensor and sensed energy storage capacity data from the energy storage sensor to determine range by determining a mean of energy storage capacity data, determining a slope of the energy storage capacity data, determining an intercept of the energy storage capacity data, and applying a least square linear regression to the determined mean, determined slope and determined intercept to find the remaining range.

### CROSS-REFERENCE TO RELATED APPLICATIONS

This application claims the benefit of U.S. Provisional Patent Application No. 61/319,553, filed Mar. 31, 2010, the disclosure of which is incorporated herein by reference in its entirety.

### BACKGROUND

The present disclosure relates generally to a vehicle, and more particularly to a system and method for calculating the range at which the stored energy in a vehicle will be depleted as well as the total range of the vehicle.

### DESCRIPTION OF THE RELATED ART

Vehicles, such as motor vehicles, utilize an energy source in order to provide power to operate the vehicle. While petroleum based products, such as gasoline, dominate as an energy source in traditional combustion engines, alternative energy sources are available, such as methanol, ethanol, natural gas, hydrogen, electricity, solar or the like. A hybrid powered vehicle, referred to as a “hybrid vehicle,” utilizes a combination of energy sources in order to power the vehicle. For example, a battery may be utilized in combination with the traditional combustion engine to provide power to operate the vehicle. Such vehicles are desirable since they take advantage of the benefits of multiple fuel sources in order to enhance performance and range characteristics of the hybrid vehicle relative to a comparable gasoline powered vehicle. An example of a hybrid vehicle is a vehicle that utilizes a combination of electric and gasoline engine as a power source.

In such vehicles, a display provides information to indicate various conditions relating to operation of the vehicle, such as state of charge, energy consumption, or range or the like. For example, a range indicator provides information regarding the remaining amount of stored energy available, such as electric charge or a hydrocarbon based fuel, solar energy or the like. The range indicator may be employed in vehicles having one or more combinations of energy sources, .e. electric, fossil fuel, or a combination thereof. As a vehicle is driven, the energy stored in the vehicle is consumed and converted into kinetic energy, such as forward motion. In a predictable driving condition of perfectly constant speed and constant motion resistance, the rate of energy depletion can be a straight line passing through all the data points of energy consumption versus time. Using this data, it is possible to algorithmically estimate the time and or distance remaining, after which the stored energy will be completely depleted. This information can then be displayed to the operator of a vehicle via an indicator located within the vehicle, such as a display device. In order to improve accuracy usefulness to the operator of the vehicle, the algorithm can take into account other variables, such as external noise, drivers' behaviors, adaptation to changing driving conditions, or like. These variables, however, are inherently unpredictable and thus pose a problem in accurately estimating algorithmically the operating range of a vehicle. Moreover, increasing the number of variables inevitably increases the difficulty of calculating operating range, defining relatively accurate mathematical model and/or prediction.

Predictive range techniques, also referred to as “range-to-empty systems” are known and vary among different automakers. Known range-to-empty systems and methods utilize filtering algorithms which attempt to predict, or extrapolate, the fuel and/or energy consumption based on past energy usage. The consequence of such an approach is that the algorithms must be heavily damped in order to avoid instability in the display devices, such as a gauge. However, heavy damping of the drive display output may result in unsatisfactory performance and inaccurate driving range predictions. In addition, the accuracy of existing techniques may be compromised when the vehicle utilizes more than one energy source.

Thus, there is a need in the art for a system and method for more accurately calculating the range-to-empty values of a vehicle operating in an electric-only mode, combined fuel-electric mode, and/or a gasoline only mode.

### SUMMARY

Accordingly, the present disclosure relates to a system for calculating the operating distance range remaining for a vehicle. The system includes: (a) a driver input sensor for sensing predetermined vehicle operating condition data; (b) an energy storage sensor for sensing energy storage capacity data of a corresponding energy supply mechanism; (c) a controller in communication with the driver input sensor and the energy storage sensor, wherein the controller includes a memory and a processor; (d) an executable range calculation software program stored in the memory of the controller, wherein the range calculation software program uses sensed vehicle operating condition data from the driver input sensor and sensed energy storage capacity data from the energy storage sensor to determine range by determining a mean of energy storage capacity data, determining a slope of the energy storage capacity data, determining an intercept of the energy storage capacity data, and applying a least square linear regression to the determined mean, determined slope and determined intercept to find the remaining range; and (e) a display device in communication with the controller, wherein the display device receives the determined remaining range and displays the remaining range on the display device for use by a user.

The present disclosure further provides for a method of calculating a distance range at which the energy used by a vehicle will be depleted. The method includes the steps of (a) sensing a predetermined vehicle operating condition using a driver input sensor for sensing predetermined vehicle operating condition data; (h) sensing energy storage capacity data of an energy supply mechanism using a corresponding energy storage capacity sensor; (c) calculating a distance range remaining for the vehicle by the energy supply mechanism in a vehicle controller using an executable range calculation software program stored in a memory of the controller which applies a least square linear regression to the sensed energy storage capacity; and (d) displaying the calculated distance range remaining on a display associated with the vehicle for use by the operator of the vehicle.

An advantage of the present disclosure is that a system and method of calculating the range-to-empty of a vehicle is provided that is more efficient and more accurate than other techniques. Another advantage of the present disclosure is the application of statistical methods and calculations using a least squares linear regression may be utilized in determining the range-to-empty t. Yet another advantage of the present disclosure is that the methodology used can be more responsive and adaptive to varying vehicle operating conditions, such as driving styles, grade angles, accelerations, decelerations, loads, energy regeneration events, and other input disturbances. An even further advantage is that the methodology can learn vehicle behavior and adapt accordingly to improve accuracy of prediction. A yet even further advantage of the present disclosure is that the methodology provides for quick and accurate calibration of the system. Still yet an even further advantage of the methodology is a significant reduction in the systems propensity for errors in estimation of range-to-empty.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a vehicle for use with the system and method for range calculation in a vehicle.

FIG. 2 is a front view of an instrument panel for the vehicle of FIG. 1.

FIG. 3 is a front view of an interactive display having a variety of indicators for the instrument panel of FIG. 2.

FIG. 4 is a front view of an instrument cluster for the instrument panel of FIG. 2.

FIG. 5 is a diagrammatic view of a system for use in range calculation for the vehicle of FIG. 1.

FIG. 6 is another diagrammatic view of the system for use in range calculation.

FIGS. 7A-7B are flow diagrams illustrating a method for range calculation for use with the system of FIGS. 5 and 6.

FIG. 8 is a graph of illustrating normalized state of charge, vehicle speed, and remaining range using the methodology of FIGS. 7A-7B.

### DESCRIPTION

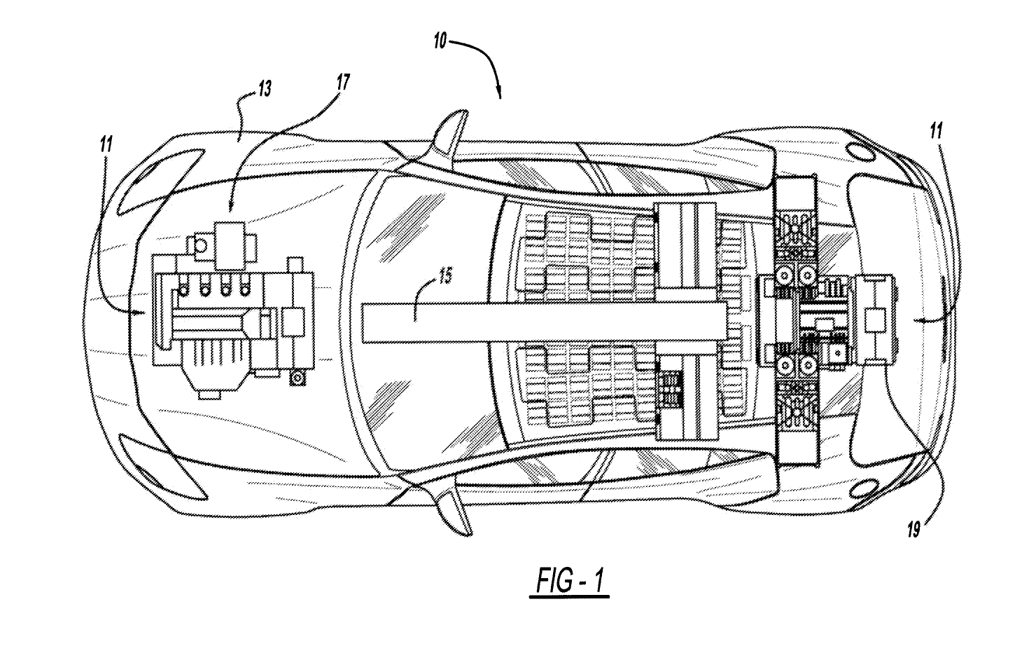

Referring generally to FIGS. 1-6, a system for range calculation in a vehicle is illustrated. The system is implemented in a vehicle 10. Vehicle 10 can be any hybrid vehicle including a solar and electric powered vehicle, a combustion engine and electric vehicle, a plug-in hybrid vehicle having a battery that obtains an electrical charge from a standard electrical outlet, or a fully electric battery powered vehicle. Generally, vehicle 10 includes a body structure 13 having a frame surrounding and typically enclosing an interior space 12 referred to as a passenger compartment. In this example the vehicle 10 can be a plug-in hybrid vehicle powered by an internal combustion engine 17 and a battery 15 operable to be charged off-board. Both the engine 17 and the battery 15 can function as a power source for the vehicle 10. The vehicle 10 can be powered by each power source independently or in cooperation. A hybrid vehicle that uses a series configuration, such as an engine driving a generator and the generator providing electrical power to a drive motor, can utilize this architecture. The vehicle 10 could be a passenger vehicle, truck, off-road equipment, etc. Vehicle 10 also includes a power train 11 that operatively controls movement of the vehicle. A motor 19, that mechanically drives an axle of the vehicle that moves wheels of the vehicle, is powered by the power sources (i.e., a battery, engine, and/or generator). In the example of FIG. 1, vehicle 10 is a rear wheel drive vehicle with the rear wheels mechanically driven by motor 19.

The vehicle 10 includes a power train 11 that controls the operation of the vehicle. In this example, the power train is a plug-in hybrid, and includes an electrically powered motor 19 coupled to a motor controller. The vehicle includes a gasoline powered engine 17 that supplements the electric motor when required under certain operating conditions. The electrical energy is stored in an energy storage device, such as the battery 15. The battery 15 may be a single unit, or a plurality of modules arranged in a predetermined manner, such as in series to be described in more detail below. Various types of batteries are available, such as lead acid, or lithium-ion or the like. The vehicle 10 may include more than one type of battery 15 or energy storage device. The battery 15 supplies the power in the form of electricity to operate various vehicle components. In this example, there is a low voltage battery (not shown) that provides electrical power to vehicle components such as the various auxiliary systems and a high voltage battery 15 (i.e. 400 V traction battery) that provides electrical power to an electric drive motor 19. The battery may be in communication with a control system that regulates the distribution of power within the vehicle, such as to the electric drive motor, or a vehicle component or other accessories or the like. In this example, the high voltage battery receives electrical energy from a plug-in source, and the low voltage battery receives electrical energy from a solar source and from the higher voltage battery as needed. The energy storage capacity of the engine 17 and battery 15, and depletion of energy from both the engine and battery, determine the operating range of the vehicle.

The interior 12 includes an instrument panel (IP) 14 which can be defined as a dashboard or an instrument cluster (IC) 14. A display device such as a human machine interface (HMI) 16 is shown at a relatively center location of the front area of the interior of the vehicle.

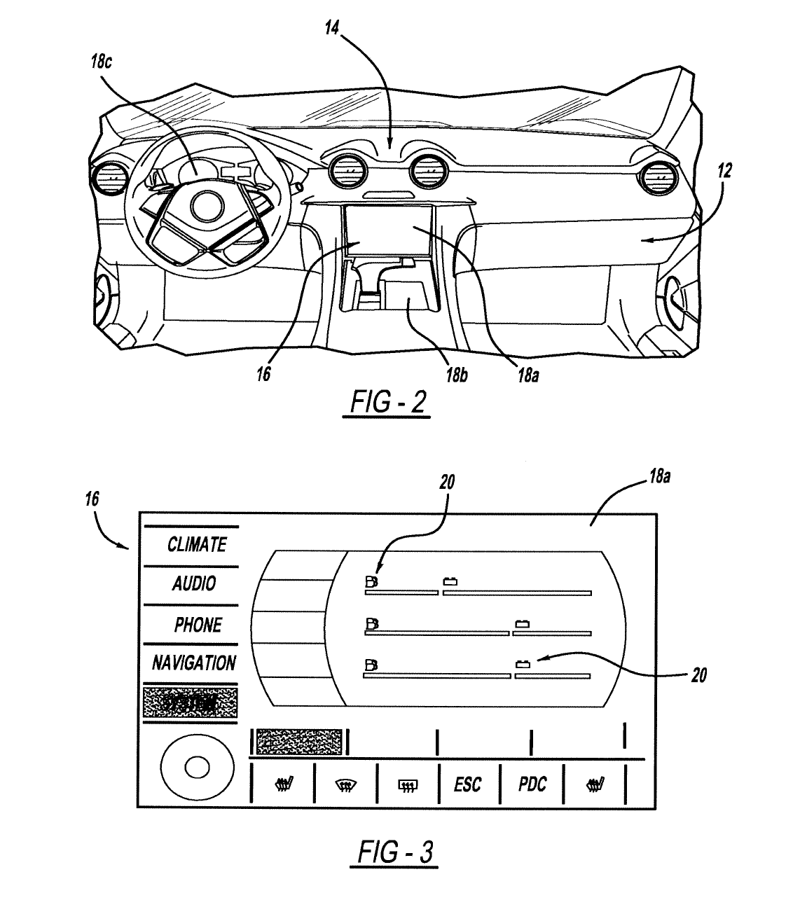

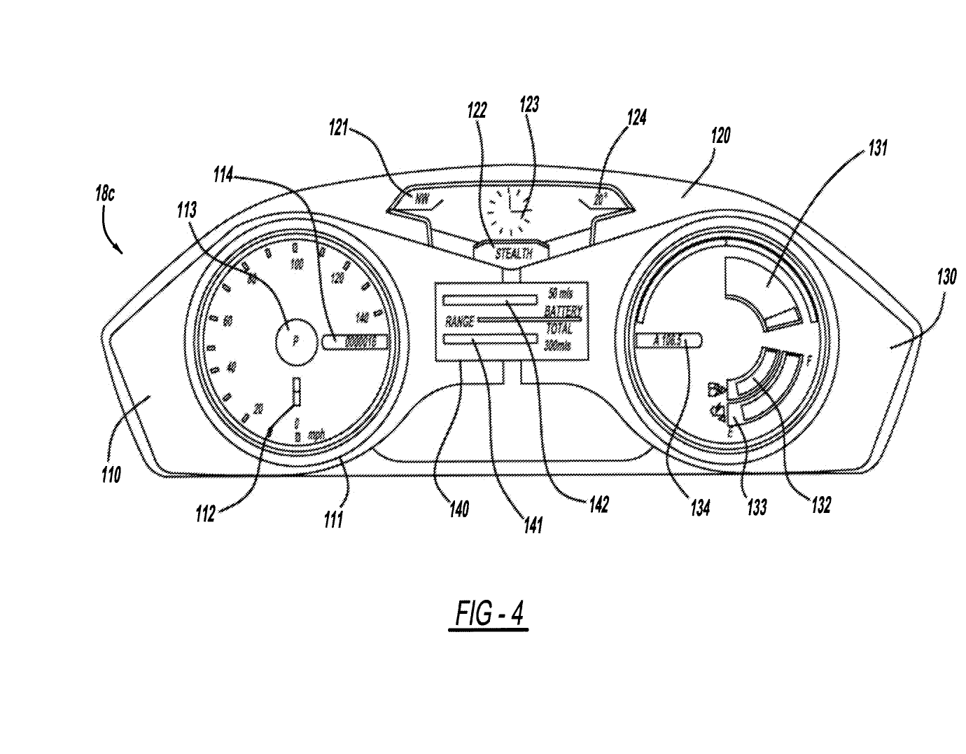

The instrument panel 14 extends laterally in the front portion of the vehicle 10 from one side of the vehicle 10 to the other side of the vehicle 10, as shown in FIG. 2. The instrument panel 14 may support a variety of visual displays 18A, 18B, and 180 that provide a variety of information pertaining to vehicle 10, such as safety, performance, or the like. In an example. HMI 16 typically defines a display 18A. Display 18A may be an interactive display device that enables the operator and/or occupant of the vehicle 10 to control and regulate the features of the vehicle 10. These features can include interior climate; audio system features, phone, navigation, or the like, as shown in FIG. 3. The display 18A may also include a variety of visual and/or audible indicators 20 informing an operator or occupant of the vehicle 10 of issues such as low tire pressure, low fuel, or the like.

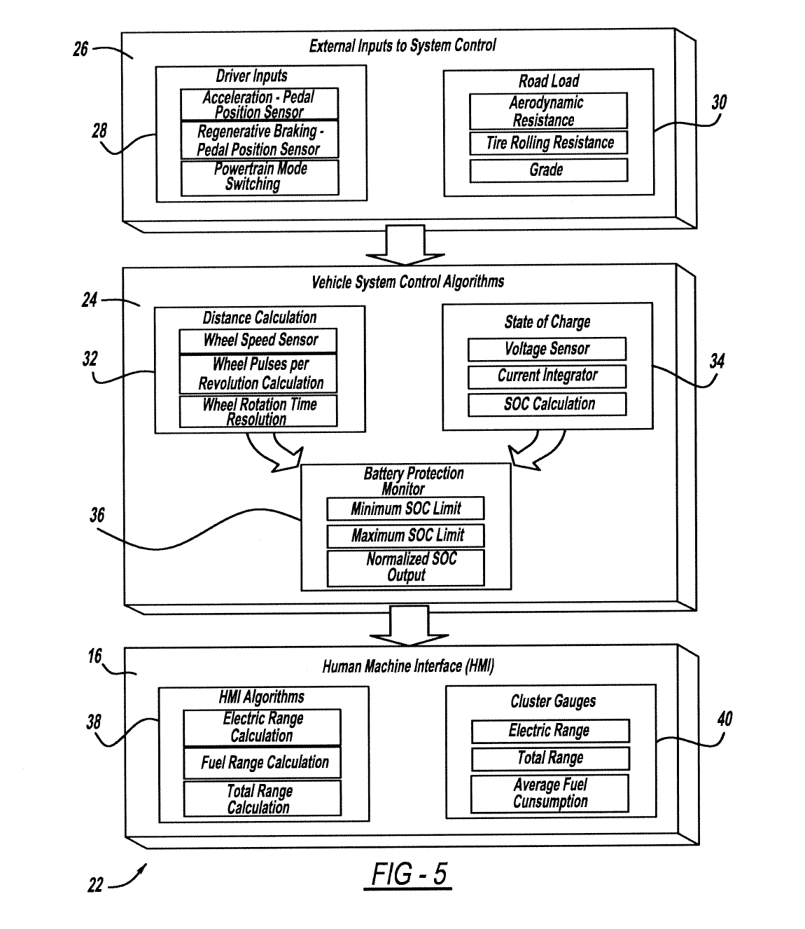

A display 180, as shown to FIG. 4, can be located on the dashboard 14 directly in view of the operator of the vehicle. This can be referred to as a center instrument cluster 18C. Cluster 180 can be provided in the vehicle as a separate dedicated electric display in communication with a vehicle computer or mounted on a dedicated calculating device that computes various information to be displayed and is in communication with a computer of the vehicle. Display 18C can display critical driving information such as vehicle speed, fuel tank level, battery life, and the like.

In this example, cluster 18C includes a generally circular speedometer 111 positioned on a left side portion 110 of cluster 18a Speedometer 111 includes a speedometer bar 112. A gear mode indicator 113 is shown in the center of the speedometer 111. An odometer 114 is also shown adjacent the central gear mode indicator.

In an example, cluster 13C further includes an upper cluster 120 that defines several measurable indicators such as, compass 121, driving mode 122, clock 123, and external temperature 124. In a right side portion 130 of cluster 18C, an example circular cluster of energy consumption is shown including a battery energy consumption indicator 131, fuel level bar 132, and charge level bar 133. A trip A/B indicator 134 is also provided within the right side portion 130.

In a central portion 140 of cluster 18C, a distance or range indicator is provided. In this example, the range indicator includes a total range indicator 141 and an electric distance range indicator 142. The vehicle 10 is able to travel until the energy available is depleted, otherwise known as the range-to-empty. The range-to-empty feature and values are displayed in indicators 141 and 142, as provided by the distance calculation system 22.

In an example of FIG. 2, the vehicle 10 is a plug-in hybrid vehicle that is gasoline and electric powered. The vehicle 10 may be a passenger car, truck, or other type of vehicle having a battery system 18. In another example, the vehicle is a dedicated battery powered vehicle.

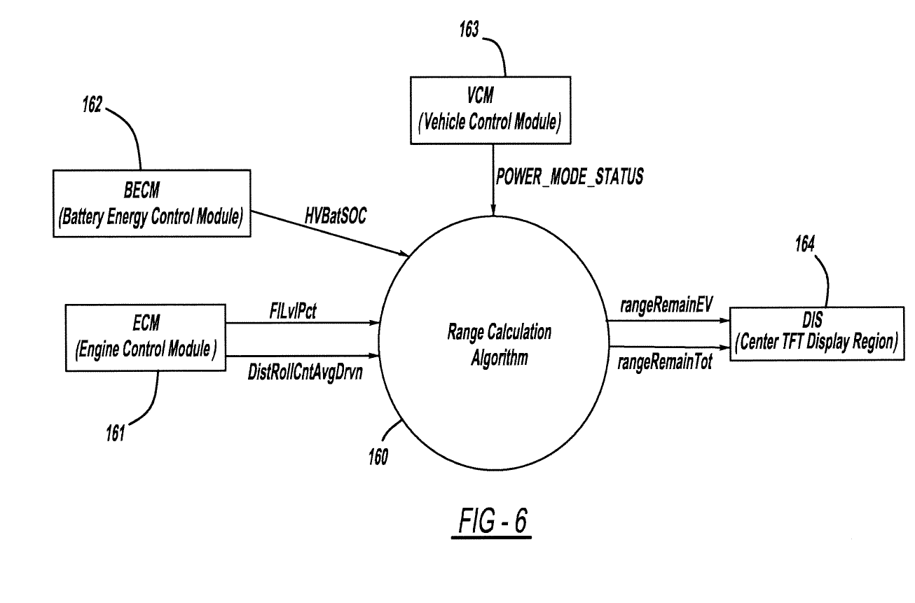

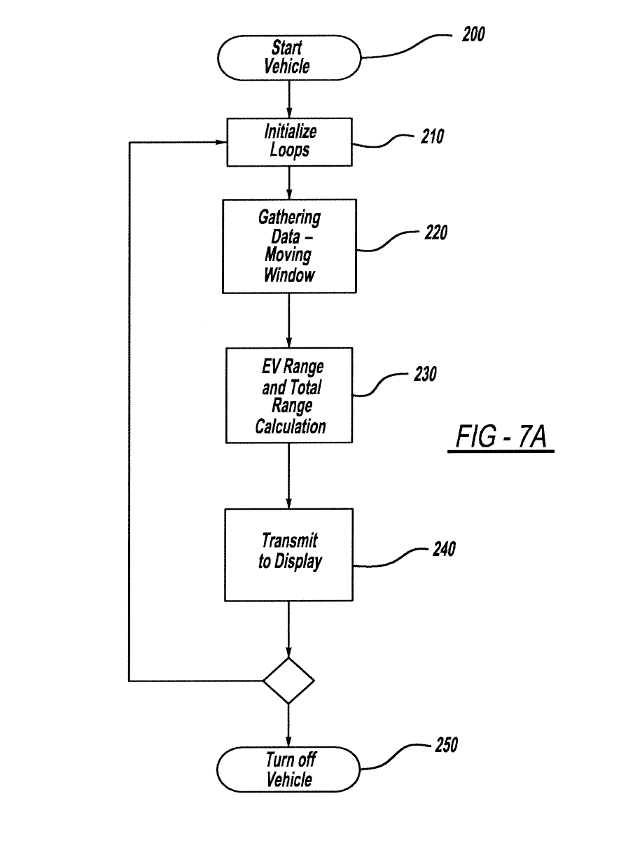

Referring to FIGS. 5-6, a system 22 for range calculation is provided. System 22 includes a system controller 24 which can include a processor and a memory. An executable software program may be stored in the memory associated with the controller 24. The controller can receive one or more external inputs 26, such as from sensors associated with the vehicle, i.e. a speed sensor, a distance sensor or the like. The controller 24 is operatively in two way electrical communication with a display device, such as the display 18C of this example. Individual components are in operable communication with one another and transmit and/or receive data to one another such that the vehicle calculation system 22 can calculate and display a variety of calculations, such as the vehicle range-to-empty calculation.

External inputs (e.g., sensors, etc.) 26 are operable to detect and provide a variety of inputs, such as driver inputs 28 and road load inputs 30, or the like, to the system controller 24. The driver inputs 28 may include an accelerator pedal position sensor, regenerative braking pedal position sensor, powertrain mode switching, or the like. The road load inputs 30 may include characteristics such as aerodynamic resistance, tire rolling resistance, or the like. The data received from the external inputs 26 are likewise transmitted to the vehicle system controller 24.

The system control computer 24 utilizes a variety of algorithms stored in a memory associated therewith that enable the system to perform various tasks, such as calculations, estimations, and monitoring, or the like. Examples of algorithms include a distance calculation 32, a SOC estimator 34, and a battery protection monitor 36, or the like. The distance calculation 32 is calculated using data such as wheel speed sensor data, wheel pulses per revolution calculations, and wheel rotation time resolution data. The SOC estimator 34 uses data such as voltage sensor data, current integrator data, and SOC calculations. The battery protection monitor monitors battery conditions such as the minimum SOC limit, the maximum SOC limit, and the normalized SOC output. The calculated results, i.e. in the form of data or estimations, etc. are transmitted to a display of the vehicle such as display 18C.

The system is in communication with a display device, such as a human-machine interface (HMI) 16. The human machine interface may have an integral controller and processor. Data from the vehicle system control computer 24 is received by the HMI 16 and the HMI algorithms 38 perform various functions. Although the HMI 16 can have its own controller to perform these calculations, the HMI 16 can merely be a display device and the calculations performed in another device (e.g., vehicle controller, etc.) associated with the vehicle. These calculations are then used to display information, such as, electric range, total range, average fuel consumption, or the like, on the display screens of the HMI 16. The range calculations of this example may be performed in any one of the controllers associated with the vehicle. In this example, the calculation is performed by a controller associated with the HMI.

In an example, a vehicle includes several dedicated controllers often referred to as control units or control modules. Referring to FIG. 6 diagrammatic view of the system associated with the present disclosure illustrates communication between several components of an example vehicle 10. In an example, a controller having an executable range calculation algorithm 160 stored therein receives data from several components of the vehicle. An engine control module (“ECM”) 161 measures percentage of fuel remaining or consumed by the vehicle which contributes to measuring fuel distance range remaining. The ECM 161 delivers fuel level percentage data (“FlLvPct”) and distance driven data (“DistRollCntAvgDrvn”) to the algorithm 160. A battery energy control module (“BECM”) 162 can be provided to measure state of charge (“SOC”) of a high voltage battery (“HVBatSOC”) which contributes to measuring the electronic distance range of the vehicle. The ECM 161 and BECM 162 communicate information to the range calculation algorithm 160. As previously described, the range calculation algorithm 160 can be hosted on software in a dedicated vehicle controller (“VCM”) 163, a hybrid controller, or a driver information system (“DIS”) 164 that is communication with a display (such as display 18C) and is able to calculate distance ranges. In the example of FIG. 6, the VCM 163 also communicates a signal containing vehicle start and stop operation (“POWER_MODE_STATUS”) to the controller. The SOC and fuel remaining are key variables in determining total distance remaining on the vehicle since the total range (indicated in indicator 141) is the sum of the electric range 142 plus the fuel range. The output from the range calculation algorithm 160 is transmitted as a signal from the controller. In this example, the output feeds into the DIS 164 providing both the electric range (“rangeRemainEV”) and the total range (“rangeRemainTot”) to the DIS 164. Fuel range of the gasoline fuel relatively easier to calculate or estimate since it is a discrete amount that is continually being depleted from the fuel reservoir or tank. SOC fuel range can vary under certain circumstances, such as if engine or regenerative breaking occurs, for example, and are used to charge the high voltage battery. Accordingly, SOC measurements during vehicle activity can vary drastically providing data points that do not align linearly as SOC is consumed.

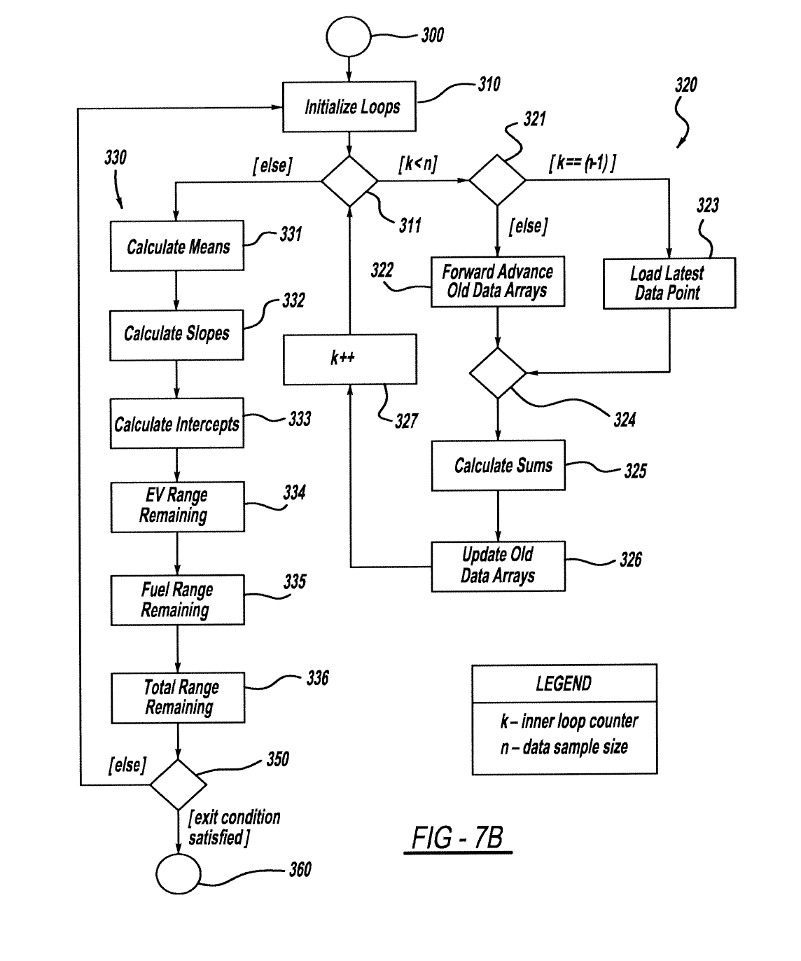

Referring now to FIGS. 7A-7B, a methodology for calculating the range-to-empty of a vehicle 10 is shown. The method is implemented by the vehicle system previously described. The method employs a least squares linear regression algorithm in order to calculate the operating range of the vehicle based on a measurable parameter, for example SOC. FIG. 7A provides an overview of the methodology. Accordingly, the methodology initiates when the vehicle box 200 with starting the vehicle. For example, the vehicle is keyed on. The methodology advances to box 210. In box 210, initial variables are established. For example, initial variables are predetermined values of fuel capacity that are selectively determined. The methodology advances to block 220.

In box 220, data from the various inputs are transferred to the controller. Examples of input data include wheel speed from the wheel speed sensor, state of charge from the voltage sensor or the like. The collection of the initial data can be referred to as a moving window since the gathering points are continuously advancing, leaving the earliest data point out of the calculation. The methodology advances to box 230.

In block 230, electrical range (EV Range) and total range is determined. For example, the electrical range and total range is determined using the methodology described with respect to FIG. 7B. Once the ranges are calculated, the methodology advances to box 240, and the information is transmitted to a display device (such as display 18C) and displayed thereon for viewing by an operator.

The display may be discrete or continuous, thus, the methodology then advances to decision box 250 where it loops back to the initialization step of box 210 and continues or ends resulting from turning off the vehicle in box 260.

Referring now to FIG. 7B a method for calculating the range using a linear regression algorithm is provided. Employing a linear regression technique enables linear modeling of the relationship between one or more variables denoted as y and one or more variables denoted x in equation (1) below, such that the model depends linearly on the unknown parameters (e.g., range-to-empty of the vehicle, etc.) to be estimated from the data. Employing linear regression also enables the creation of a linear model in which the conditional mean of y given the value of x is a finite function of x. The linear model can then be fitted using the least squares approach, which is a technique for fitting data. The “best fit,” between modeled data and observed data, in its least-squares sense, is an instance of the model for which the sum of squared residuals has its least value, where a residual is the difference between an observed value and the value provided by the model. The algorithm corresponds to the maximum likelihood criterion if the experimental errors have a normal distribution.

Referring to FIG. 7B, the methodology begins in circle 300 with the step of starting the vehicle, as previously described. The methodology advances to box 310 and initial parameters are established, as previously described with respect to FIG. 7A.

The methodology advances to decision box 211. In decision box 311 it is determined whether there is sufficient data to determine the range. For example a counter may be utilized to determine if sufficient data points have been acquired and transmitted to the controller. The variable “k” is the inner loop counter for consecutive loops and “n” is the data sample size which is a calibrated point which is predetermined for desired adaptability. If sufficient data points have not been gathered, then the methodology advances to decision box 321.

In decision box 321, it is determined if k is equal to a predetermined value, such as (n−1). If it is equal to the predetermined value, then the methodology advances to box 323 where the latest data point is loaded. The methodology advances to decision box 324 and it is determined whether to continue gathering data. If determined to continue gathering data, the methodology advances to decision box 325, and the sum of the desired values, for example SOC data, are calculated. Referring back to decision box 321, if the k value is other than (n−1) than the methodology advances to box 322, in box 322, old data arrays which are stored in a memory component of the system are advanced. Accordingly, this allows the system to generate data at initiation to begin learning behavior of the vehicle. The methodology advances to box 324 and then continues to the sum calculation of box 325, as previously described. The methodology advances to box 326 and the old arrays are then updated. The methodology advances to box 327 to add to the counter (k) count represented by “k++” representing the number of data points. The methodology then returns to decision block 311 and continues. It should be appreciated that the data gathering steps described with respect to the moving window of step 220 is continuous after the system is initiated.

Returning back to decision block 311, the methodology advances to box 331 if determined that there is sufficient data to calculate the range using the linear regression algorithm to be described. In block 331, the mean of the data points associated with the state of charge, or energy capacity, or fuel tank level are calculated. The methodology advances then to box 332 where the slope of the previously collected data points associated with the state of charge, energy capacity or fuel tank level are calculated. The methodology advances to block 333 and uses the means and slopes to calculate the intercept values for the data.

The methodology advances to box 334 and determines the remaining electric energy range once the mean, slopes, and intercepts are calculated. Linear regression modeling includes the step of assuming that in most cases the overall trend and rate of energy depletion over time is linear. The “best” fitting straight line to a set of data points is determined. For example, a, least squares linear regression analysis is employed to find the “best” fitting straight line to a set of data points. The mathematical expression for a straight line is determined using:

y=a₀+a₁x (1)

where a₀ and a₁ coefficients representing the intercept and the slope respectively. The slope of the energy depletion is determined. For example, the least square linear regression algorithm determines the slope of the energy depletion based on the following formula:

a₁=nΣxᵢyᵢ−Σxᵢyᵢ/nΣxᵢ²−(Σxᵢ)² (2)

where the value of i is the sample size.

The means of x and y and the intercept value are then determined. For example, after solving for the slope a1, based on the formula above, the means of x and y are calculated, and the intercept value is solved for as follows:

a₀= y̅−a₁ x̅ (3)

A future moment in time is then determined when the energy will be depleted to a predetermined value, such as zero. For example, the moving sample of the most recent data, and the linear trend defined by the coefficients a1 and a0, may be utilized by the algorithm to extrapolates a future moment in time when the energy will become depleted to zero such as by using:

xₑₓₜᵣₐₚ=−a₀/a₁ (4)

The methodology determines the remaining extrapolated time to deplete a predetermined amount of the stored energy. For example as the vehicle is consuming the available energy, the SOC data samples are constantly being consumed by the algorithm and the old SOC data samples are being replaced with new samples. Therefore, the remaining extrapolated time to deplete all of the energy, at a time when the sample i is acquired, is calculated as follows:

timeᵣₑₘₐᵢₙ=xₑₓₜᵣₐₚ−xᵢ (5)

The average vehicle speed (“v_{avg}”) is simply the distance traveled, divided by the time expired.

Finally, the remaining range is:

Rangeᵣₑₘₐᵢₙ=timeᵣₑₘₐᵢₙ*v_{avg} (6)

The driving range can be predicted using statistical analytical techniques such as linear regression. For example, utilizing statistical methods in real-time, such as the least squares linear regression as in the present disclosure, a suitable and relatively stable prediction of the driving range in either electric or fuel modes may be determined. This algorithm also adapts better than the traditional algorithms employed to varying driver behaviors and road load. During traveling, the lesser the remaining amount of onboard fuel energy), the more accurately the algorithm will converge on the remaining range value. The calculated range to energy depletion is displayed on a display device, which in this example is referred to as a human machine interface.

The methodology advances to block 335 and calculates the remaining fuel range based on fuel tank remaining values. For example, the linear regression technique previously described with respect to the state of charge may be utilized.

The methodology advances to block 336 and determined the total range remaining. For example, the EV remaining range is summed together with the fuel remaining range to obtain the total range remaining calculation.

The methodology advances to decision box 350 and determines if a predetermined condition is met to continue calculating the range. An example of a predetermined operating condition is whether the vehicle is still operating. Another example of a predetermined operating condition is whether the vehicle is keyed on. If the predetermined operating condition to continue calculating the range is met, the methodology returns to clock 310 and continues. If the predetermined condition is not met, of the methodology advances to circle 360 and ends. It should be appreciated that the order of implementation of the steps may be varied.

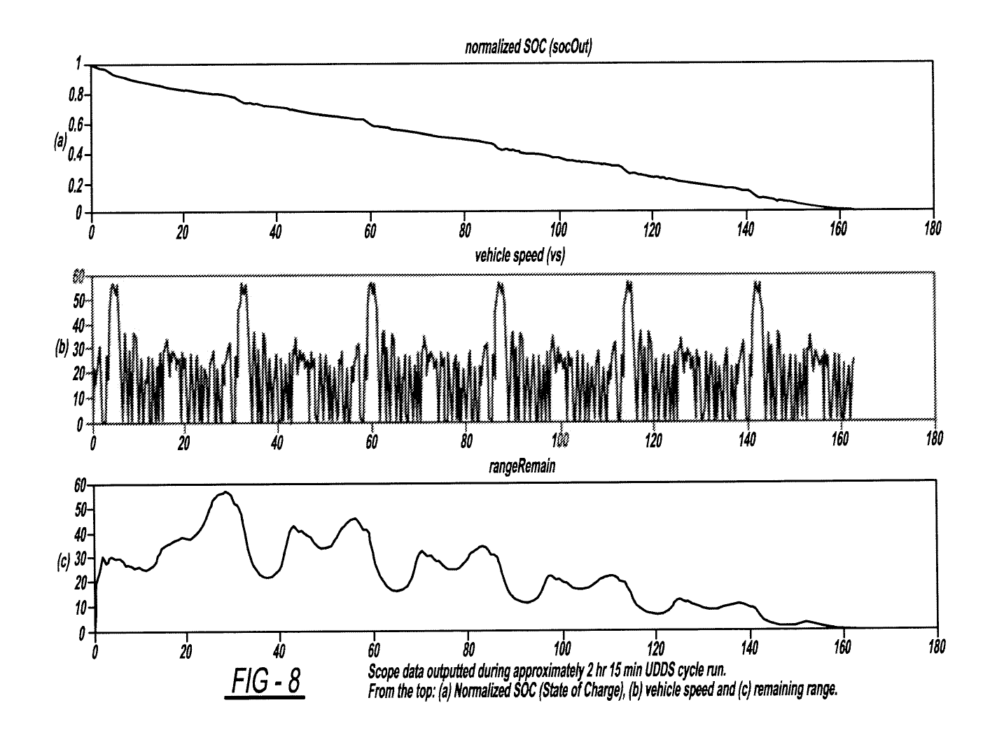

FIGS. 8(a)-8(c) illustrate example graphs of data points of vehicle operation over a fixed amount of time. In this example, the time is 2 hours and 15 minutes. The data shows (a) normalized SOC over time decreasing from 100 to zero and thus complete depletion of the high voltage battery charge. It is noted that in vehicle operation, typically the battery is not depleted below a certain threshold such as 10% to avoid destroying the battery. Vehicle speed in (b) is shown over the same time period and varying randomly in a range from zero to 60. In (c), the remaining range shown in distance value is shown as decreasing but not necessarily linearly as a result in speed and SOC depletion. Accordingly, as shown by 8(c), the range remaining can vary in a significantly nonlinear graphical model and thus providing a more accurate prediction than traditional linear calculations.

Many modifications and variations of the present disclosure are possible in light of the above teachings. Therefore, within the scope of the appended claim, the present disclosure may be practiced other than as specifically described.

What is claimed is:

1. A system for calculating the operating distance range remaining for a vehicle comprising:
(a) a driver input sensor for sensing predetermined vehicle operating condition data;
(b) an energy storage sensor for sensing energy storage capacity data of a corresponding energy supply mechanism;
(c) a controller in communication with the driver input sensor and the energy storage sensor, wherein the controller includes a memory and a processor;
(d) an executable range calculation software program stored in the memory of the controller, wherein the range calculation software program uses sensed vehicle operating condition data from the driver input sensor and sensed energy storage capacity data from the energy storage sensor to determine range by calculating a mean of energy storage capacity data, determining a slope of the energy storage capacity data, determining an intercept of the energy storage capacity data, and applying a least square linear regression to the determined mean, determined slope and determined intercept to find the remaining range; and
(e) a display device in communication with the controller, wherein the display device receives the determined remaining range and displays the remaining range on the display device for use by a user.

2. The system of claim 1 wherein the energy supply mechanism is a battery and the energy storage sensor determines battery state of charge.

3. The system of claim 2 wherein the battery data is measured continuously during vehicle operation to calculate distance range for electric energy depletion of the battery.

4. The system of claim 2 wherein the battery state of charge is measured by a battery energy control module.

5. The system of claim 1 wherein the energy supply mechanism is an engine and the energy storage sensor is a fuel tank level sensor.

6. The system of claim 5 wherein the determined range is the total distance range remaining for energy supplied by both the battery and the gasoline engine.

7. A method of calculating a distance range at which the energy used by a vehicle will be depleted, the method comprising the steps of:
(a) sensing a predetermined vehicle operating condition using a driver input sensor for sensing predetermined vehicle operating condition data;
(b) sensing energy storage capacity data of an energy supply mechanism using a corresponding energy storage capacity sensor;
(c) calculating a distance range remaining for the vehicle by the energy supply mechanism in a vehicle controller using an executable range calculation software program stored in a memory of the controller which applies a least square linear regression to the sensed energy storage capacity; and
(d) displaying the calculated distance range remaining on a display associated with the vehicle for use by the operator of the vehicle.

8. The method of claim 7 wherein the step of calculating the distance range remaining further includes the steps of:
(a) determining a mean of the sensed energy storage capacity data;
(b) determining a slope of the sensed energy storage capacity data;
(c) determining an intercept of the sensed energy storage capacity; and
(d) applying a least square linear regression to the determined mean, determined slope and determined intercept to find the remaining range of the vehicle.

9. The method of claim 8 further including the steps of:
(a) establishing a linear rate of energy depletion over time
(b) calculating a slope of energy depletion using a least square linear regression algorithm;
(c) calculating means and solving for an intercept value; and
(d) extrapolating into a future moment of time when energy will become depleted to zero;
(e) calculating a remaining extrapolated time to deplete all energy at a time when the sample is acquired; and
(f) calculating the remaining range using the remaining time multiplied by, distance traveled divided by the time expired.

10. The method of claim 7 wherein the step of sensing energy storage capacity further includes the step of sensing state of charge data from a high voltage battery by a battery energy control module.

11. The method of claim 10 wherein the step of sensing energy storage capacity further includes the step of sensing fuel tank level data from a fuel tank associated with an engine.

12. The method of claim 11 wherein the step of calculating the distance range remaining includes the step of adding the sensed energy storage capacity and sensed fuel tank level to predict a total distance range remaining for operating the vehicle.

13. The method of claim 7 wherein the controller and the display are an integral unit hosting a software program adapted to execute the least squared linear regression algorithm.

14. The method of claim 7 further comprising the step of using a moving window to determine energy capacity by calculating a moving set of data points eliminating earlier gathered data points.

15. The method of claim 7 wherein the vehicle is a hybrid vehicle having a high voltage battery and a gasoline powered engine to supply energy to operate the vehicle.
